(19) United States
(12) Patent Application Publication
(10) Pub. No.: US 2025/0390851 A1
(43) Pub. Date: Dec. 25, 2025

(54) Split2Own: Digital Voucher System for E-Commerce with Value Retention

(71) Applicant: Ammar Alsalih Altaheni, Essen (DE)

(72) Inventor: Ammar Alsalih Altaheni, Essen (DE)

(21) Appl. No.: 19/316,601

(22) Filed: Sep. 2, 2025

(51) Int. Cl. G06Q 20/06; G06F 7/58

(52) U.S. Cl. CPC G06Q 20/065; G06F 7/588

(57) ABSTRACT

A computer-implemented method and digital platform enhance e-commerce sales by issuing digital vouchers with actual value as redeemable merchant credit. Participants purchase vouchers and may enter a single raffle for a premium product using a voucher's nominal value, which is aggregated to match the product's value. A winner is selected using a NIST SP 800-90A-compliant random number generator with SHA-256-based voucher IDs. The platform integrates with e-commerce systems via API, displays real-time contribution progress using WebSocket, and employs machine learning to tailor voucher conditions and analyze usage data for marketing insights.

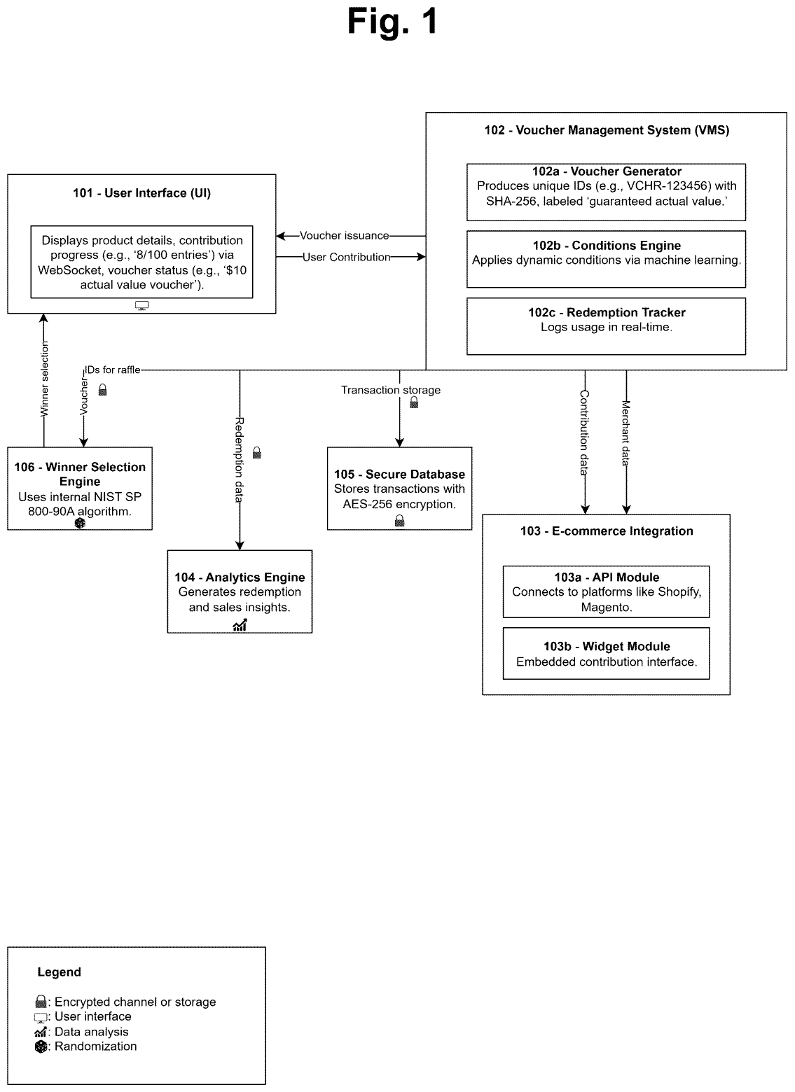

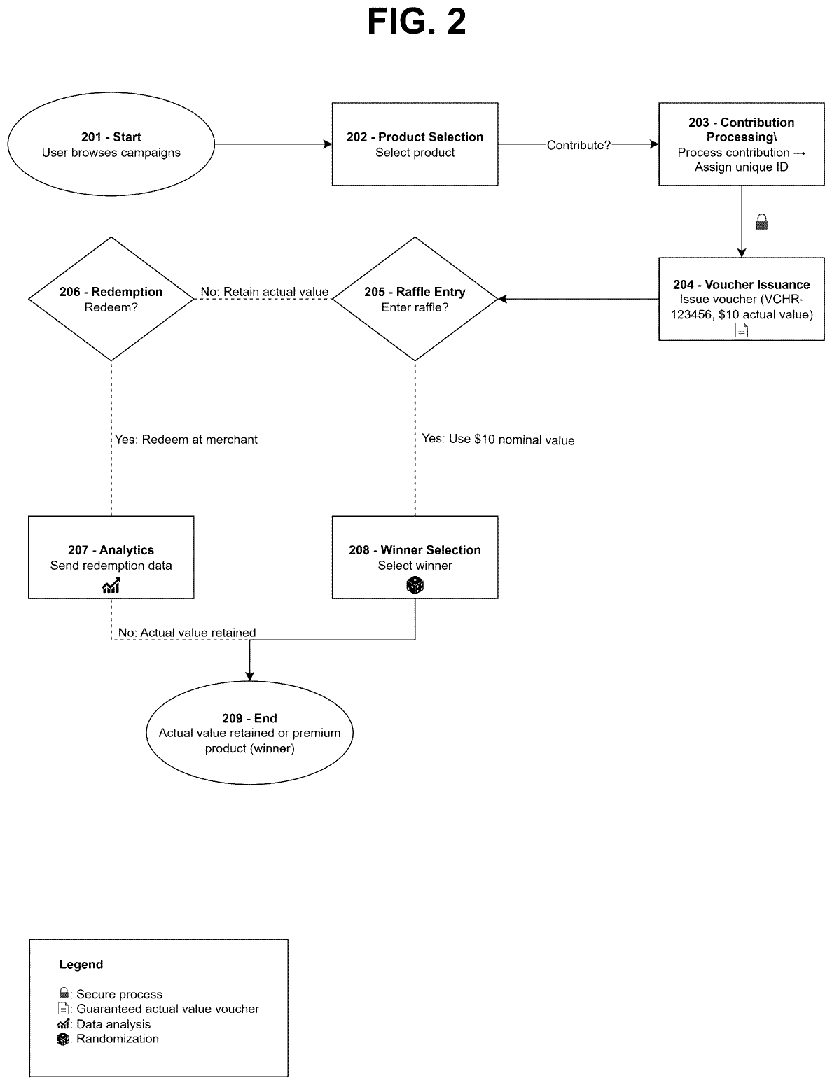

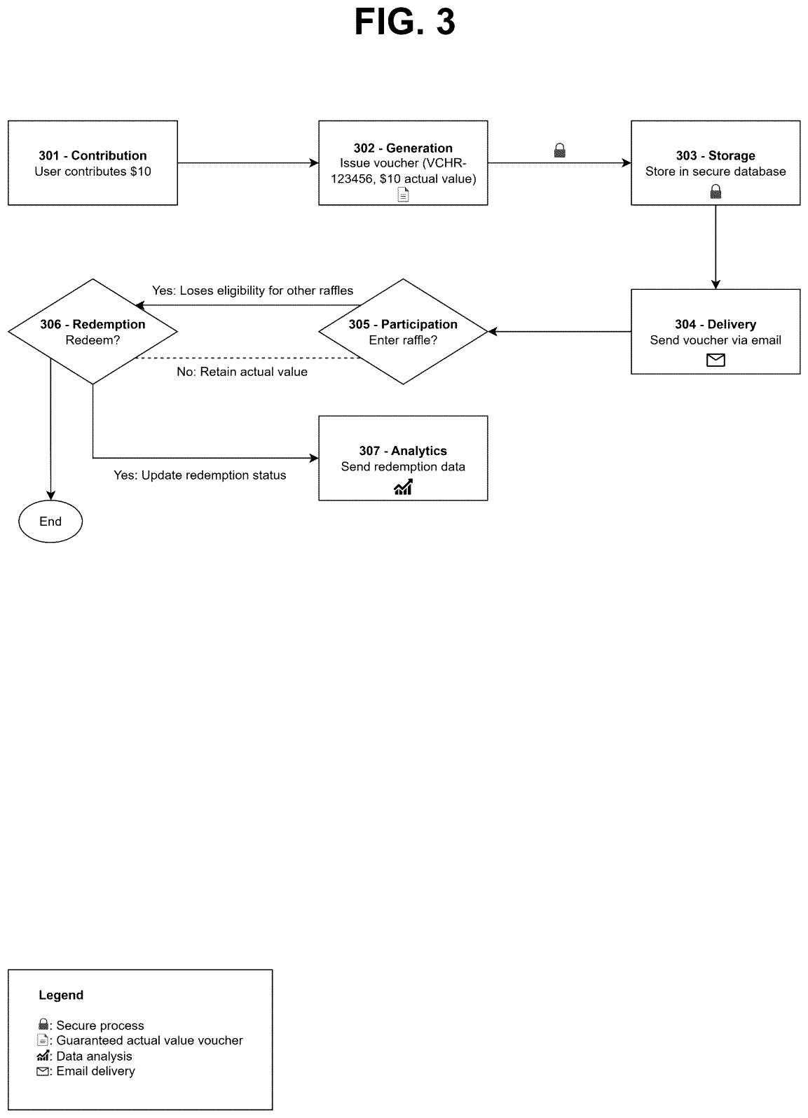

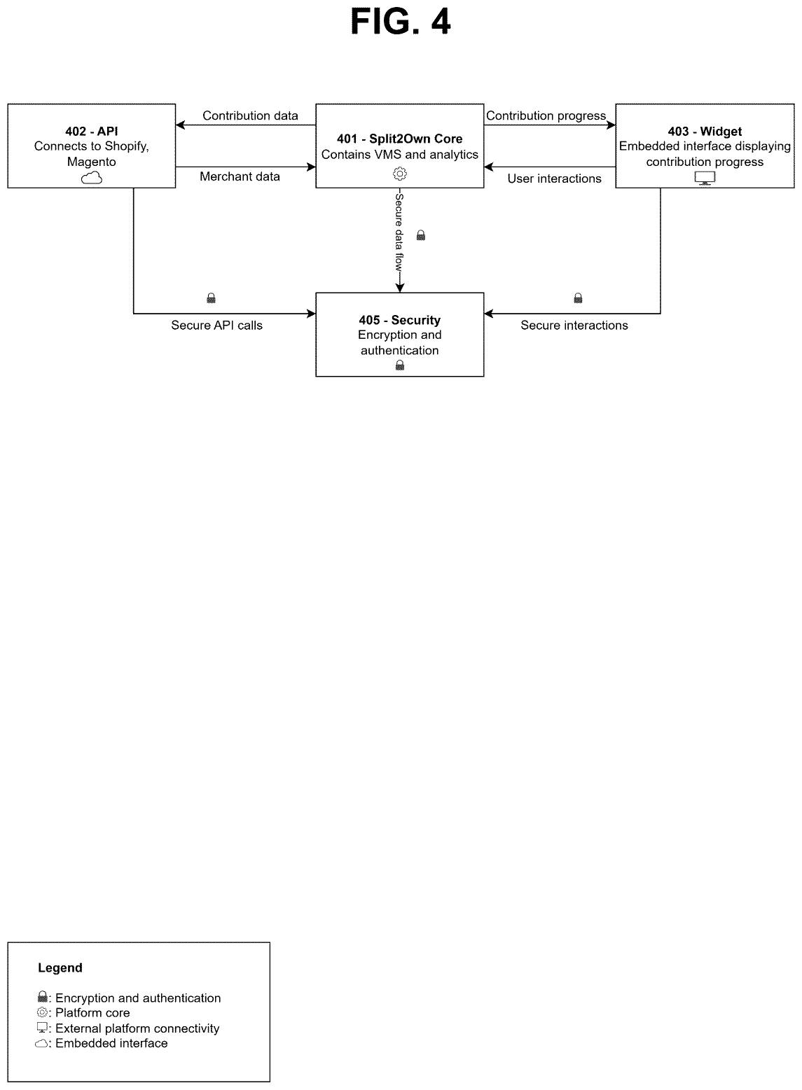

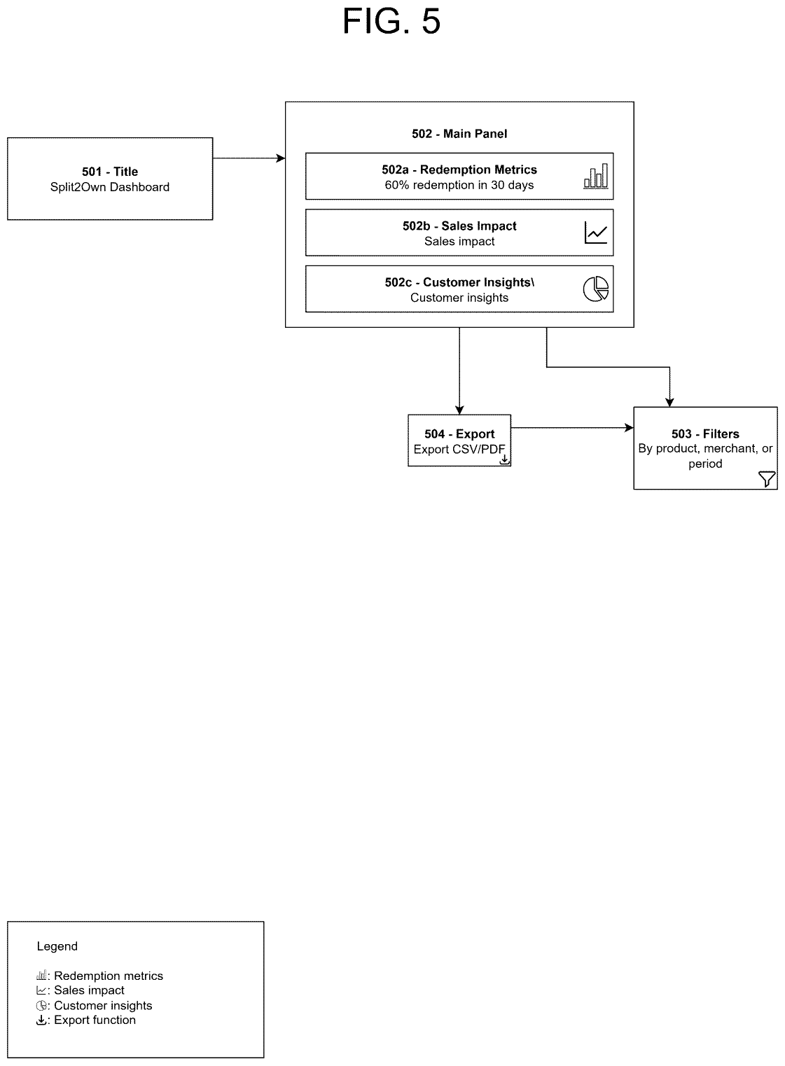

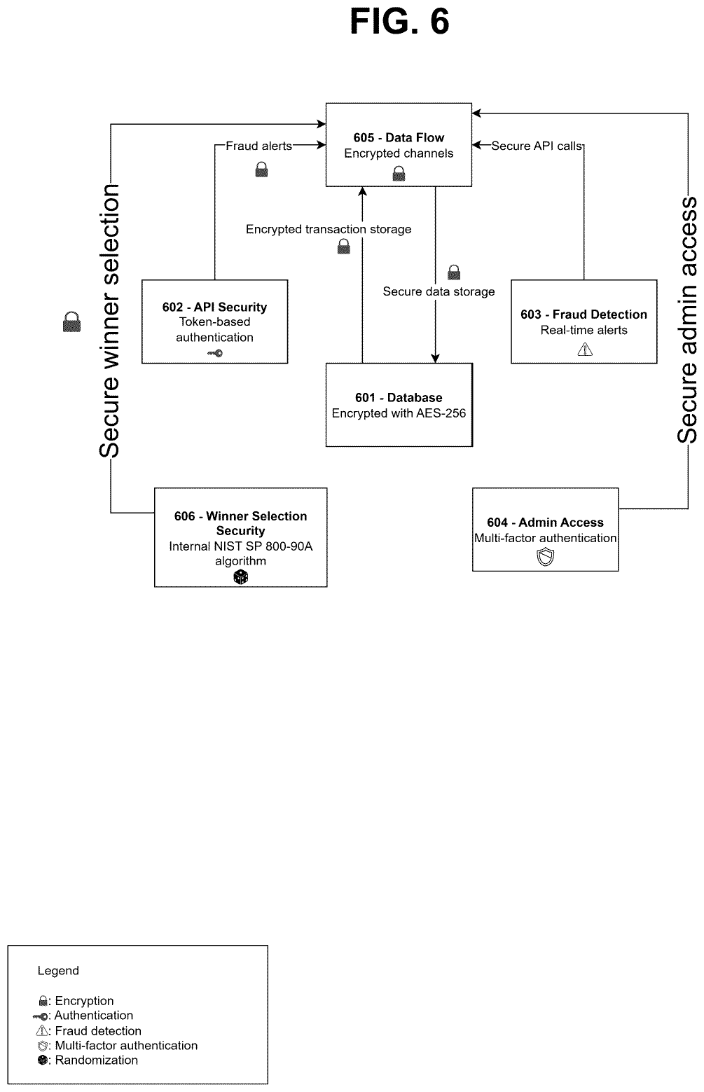

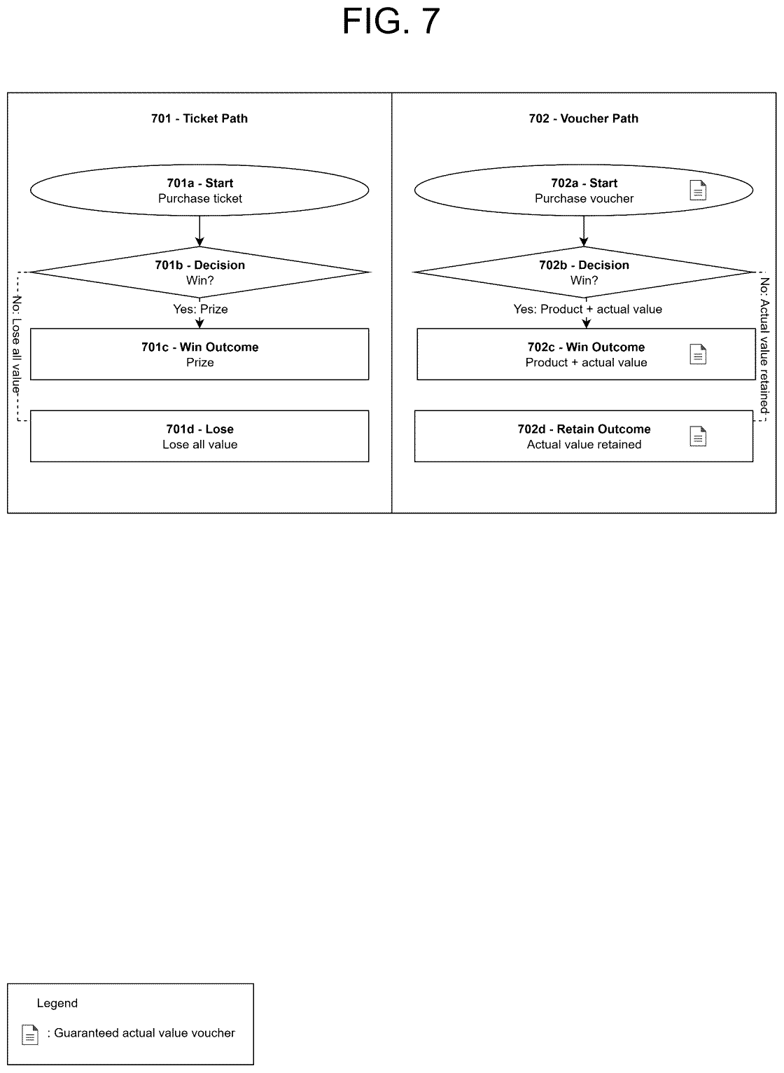

### FIELD OF THE INVENTION

This invention relates to a digital system and method for enhancing e-commerce engagement through a contribution-based platform using digital store credit vouchers that replace traditional raffle tickets, ensuring retention of their actual value as redeemable credit with partner merchants. The system integrates with e-commerce platforms to increase sales, supports flexible voucher generation by the platform or merchants based on partnership agreements, leverages machine learning-driven data analytics for marketing optimization, and employs an internal, secure, random winner selection mechanism for transparency.

### BACKGROUND OF THE INVENTION

Traditional e-commerce systems require full payment for high-value products, creating barriers for consumers with limited budgets. Existing digital voucher systems, such as loyalty programs or promotional coupons, are limited to fixed discounts or narrow incentives and lack mechanisms to convert low-value contributions into opportunities for acquiring premium products while retaining actual value as store credit.

Traditional raffle and lottery systems rely on tickets that lose all value for non-winners, resulting in high risk and low reward that discourages participation. These systems aggregate ticket sales to match the product's market value, focusing on prize distribution without guaranteeing sustained value for participants or integrating with e-commerce to boost merchant revenue.

Group-buying platforms attempt to pool purchasing power but often fail due to required minimum participation thresholds, limited product variety, and lack of flexibility to meet diverse merchant needs.

There is a need for an innovative system that converts low-value contributions into opportunities to acquire premium products while guaranteeing retention of the actual value of contributions as digital vouchers redeemable as store credit, replacing traditional raffle tickets. Unlike raffle systems focused on prize distribution or traditional voucher systems with fixed discounts, this invention prioritizes increasing e-commerce sales through seamless integration with merchant platforms, flexible voucher generation, and data-driven marketing insights, ensuring participants retain their contribution value as store credit regardless of the raffle outcome.

### SUMMARY OF THE INVENTION

The invention provides a computer-implemented method and digital platform, Split2Own, for enhancing e-commerce sales by issuing digital vouchers with actual value as redeemable merchant credit. Participants purchase vouchers and may enter a single raffle for a premium product using a voucher's nominal value, which is aggregated to match the product's value. A winner is selected using a NIST SP 800-90A-compliant random number generator seeded with SHA-256-based voucher IDs. The platform integrates with e-commerce systems via API, displays real-time contribution progress using WebSocket, and employs machine learning to tailor voucher conditions and analyze usage data for marketing insights, ensuring all participants retain their voucher's actual value as store credit.

### DETAILED DESCRIPTION OF THE INVENTION

### Core Protected Mechanism: Actual Value Retention Via Vouchers

The core of the invention is a digital system that replaces traditional raffle tickets with digital store credit vouchers, ensuring retention of each participant's actual contribution value as redeemable credit with partner merchants before and after raffle participation. The system provides an opportunity to acquire premium products as an additional reward, focusing on increasing e-commerce sales through integration with merchant platforms, flexible voucher generation, and machine learning-supported data analytics.

The system includes a secure, fully internally implemented random mechanism, fully implemented within the Split2Own platform, for transparently selecting a single winner using voucher-based contributions, ensuring each voucher is used in only one raffle, loses eligibility for other raffles after use, and retains its actual value as store credit.

### Core Process Flow

The system operates as follows:
1. Purchase Phase: Participants purchase low-value vouchers (e.g., $10) with guaranteed immediate delivery, retaining their actual value as credit redeemable with partner merchants (non-refunded as cash). Vouchers are generated by the platform based on merchant agreements or provided directly by merchants.
2. Raffle Entry Phase: Participants may opt into a raffle of their choice using a voucher with a nominal value (e.g., $10) matching the raffle's requirements. Vouchers with different nominal values, split vouchers, or multiple entries in the same raffle are not permitted.
3. Aggregation Phase: Nominal values of contributions are aggregated to cover the total value of the premium product (e.g., a $1,000 smartphone).
4. Distribution Phase: An internal, secure random mechanism selects a single winner to receive the premium product.
5. Execution Phase: All participants retain their vouchers with actual value as store credit, while the winner receives the premium product. The voucher becomes ineligible for other raffles after a single use.

### Core Transformation Mechanism

Value Retention Algorithm: The system implements:

$$( n \times Nominal value ) = Total value of the premium product$$

### Where:

n=Number of participants.
Voucher contributions=Vouchers with nominal value (e.g., $10).
Vouchers with retained actual value=Vouchers redeemable as store credit with merchants.
Premium product=Reward for one winner, who retains their voucher's actual value.

Actual and Nominal Value Definition: The actual value is the voucher's nominal face value (e.g., $10), retained as store credit with merchants throughout the process. The nominal value is used for entry into one raffle and becomes ineligible for other raffles after use. The system ensures:

$$( n \times Nominal value ) = Total value of the premium product$$

Example: For a $1,000 product, 100 participants contribute vouchers with a $10 nominal value (100×$10=$1,000). The total value may include merchant contributions or promotional tweaks, eliminating the need for cash refunds.

Voucher Management System (VMS): Generates vouchers with unique IDs (e.g., VCHR-123456) using SHA-256 hashes, either by the platform based on merchant agreements or provided by merchants. Applies dynamic conditions (e.g., $100 minimum purchase based on average basket size, or 60-day validity for specific regions) using machine learning classification algorithms based on user behavior (e.g., purchase history, location). Ensures vouchers are used in only one raffle, retaining actual value as store credit. Tracks usage in real-time and stores transactions with AES-256 encryption.

E-commerce Integration: Integrates via API with platforms like Shopify or WooCommerce, supporting contribution management and voucher provision. The widget displays product details and contribution progress (e.g., “8/100 entries”) via real-time WebSocket updates, enhancing engagement through fear-of-missing-out (FOMO) mechanics.

Analytics Engine: Analyzes usage data (e.g., redemption rates, sales impact, customer segmentation) using machine learning to adjust voucher terms (e.g., increasing minimum purchase based on purchase patterns). Provides a dashboard with downloadable reports in CSV or PDF formats.

Winner Selection Mechanism: Uses an internal encrypted algorithm based on a random number generator (e.g., NIST SP 800-90A), fully implemented within the Split2Own platform and seeded with unique voucher IDs, to select one winner transparently. Prevents multiple entries or use of non-matching nominal value vouchers, ensuring compliance with regulatory standards.

### Implementation Models

Model A: API Integration with Merchants:
Merchants provide a premium product (e.g., $1,000 smartphone).
100 participants contribute $10 nominal-value vouchers, retaining actual value, generated or provided by the merchant.
An internal random algorithm selects one winner.

Model B: Independent Multi-Merchant Platform:
The platform sells vouchers (generated or provided by merchants) and manages raffles.
Participants contribute $10 nominal-value vouchers for one raffle, retaining actual value.
An internal random algorithm selects one winner.

Model C: Hybrid Implementation:
Combines API and independent platform, with revenue streams from licensing, transaction fees, or voucher agreements.

### Technical Components

Voucher Processing System: Validates vouchers, standardizes actual and nominal values, and assigns unique IDs.

Aggregation Management: Monitors contributions in real-time, triggers distribution at thresholds, and balances using the contribution equation.

Value Retention Engine: Manages voucher inventory, supports redemption via merchant partnerships.

Winner Selection Engine: Executes an internal encrypted random algorithm to select one winner.

### Security and Compliance Framework

Transaction Security: Employs AES-256 encryption, multi-factor authentication (MFA) for administrative access, and real-time fraud detection.

Legal Compliance: Supports GDPR compliance, age verification, and auditable transaction logs.

Marketing Incentives: Vouchers drive sales via dynamic conditions tailored to user behavior, ensuring participants retain actual value as store credit based on their choice to redeem or retain vouchers.

### Revenue Models

Wholesale-Retail Pricing: Revenue from product cost-contribution margins.

Licensing Fees: Revenue from API licensing or transaction fees.

Partnership Revenue: From sponsorship fees or voucher agreements.

### Scalability and Adaptability

Supports variable voucher values, multiple currencies, and integrates with e-commerce platforms, with flexible voucher generation to meet merchant needs.

### Inventor Declaration

I declare that I believe I am the original inventor of the subject matter claimed.

### Signature:

### /Ammar Alsalih Altaheni/

### Date: Feb. 9, 2025

1. A computer-implemented method for enhancing e-commerce sales, comprising:
selling digital vouchers to participants, the digital vouchers generated by a platform based on merchant agreements or provided by merchants, each voucher retaining an actual value as redeemable credit with the merchants;
permitting the participants to enter a single raffle of their choice using a voucher with a nominal value matching the raffle's requirements, wherein multiple entries or use of non-matching nominal-value vouchers are prohibited;
aggregating the nominal values of the vouchers to equal a total value of a premium product; and
selecting a winner using an internal encrypted random algorithm based on a NIST SP 800-90A-compliant random number generator seeded with unique voucher identifiers.

2. The method of claim 1, wherein the vouchers replace traditional raffle tickets, each voucher retaining the actual value as redeemable credit with the merchants, the nominal value being used solely for the single raffle entry, and no cash refunds are provided.

3. The method of claim 1, wherein the vouchers are configured with dynamic conditions, including minimum purchase requirements or validity periods, the dynamic conditions determined by a machine learning model analyzing user behavior data.

4. The method of claim 1, further comprising integrating the platform with an e-commerce system via an application programming interface (API), wherein a widget displays real-time contribution progress to the participants using WebSocket communication.

5. The method of claim 1, further comprising analyzing voucher usage data using a machine learning algorithm to generate marketing insights, including redemption rates and sales impact, and presenting the insights via a dashboard with exportable reports in a comma-separated values (CSV) format.

6. The method of claim 1, wherein each voucher is assigned a unique identifier generated using a SHA-256 hash function, and voucher transactions are stored in a database encrypted with AES-256 encryption.

7. A digital platform for enhancing e-commerce sales, comprising:
a user interface configured to display product details and voucher conditions to participants;
an administrative interface configured for merchants to manage voucher contributions and issue vouchers based on partnership agreements;
an API module configured to synchronize data with external e-commerce platforms; and
a winner selection engine configured to select a single winner using an internal encrypted random algorithm based on a NIST SP 800-90A-compliant random number generator.

8. The digital platform of claim 7, wherein the user interface further displays a real-time counter of remaining contributions toward the premium product using WebSocket communication.

9. The method of claim 1, further comprising transmitting real-time notifications to the participants regarding contribution progress and voucher issuance via email or a mobile application.

10. The method of claim 1, wherein the participants retain control over voucher redemption, selecting to redeem the vouchers as store credit with the merchants or retain the vouchers without system-driven reinvestment of unredeemed voucher value.

11. The method of claim 1, wherein the vouchers are issued instantly upon confirmation of participant contribution, ensuring immediate delivery of the actual value as redeemable credit.

12. The method of claim 1, wherein the nominal value of the vouchers multiplied by a number of participant contributions equals the total value of the premium product, while retaining the actual value of each voucher as redeemable credit.

13. The method of claim 1, wherein the platform is configured to operate across multiple sectors, including retail and hospitality, with voucher conditions tailored by a machine learning model analyzing sector-specific user behavior data.
